(19) United States
(12) Patent Application Publication
(10) Pub. No.: US 2024/0399463 A1
(43) Pub. Date: Dec. 5, 2024

(54) Apparatus and Method for Wet Powder Dispensing for Low Temperature Metal 3D Printing

(71) Applicant: University of the District of Columbia, Washington, DC (US)

(72) Inventors: Pawan Tyagi, Derwood, MD (US); Wondwosen Demisse, Hyattsville, MD (US)

(21) Appl. No.: 18/203,333

(22) Filed: May 30, 2023

(51) Int. Cl. B22F 12/53; B22F 12/58

(52) U.S. Cl. CPC B22F 12/53; B22F 12/58; B22F 2999/00; B33Y 30/00; B33Y 70/10

(57) ABSTRACT

A device for delivering metal powder in an electrochemical 3d printing operation including a screw conveyor for carrying metal powder from a powder hopper to a vertical delivery channel, and a simultaneously reciprocating and rotating mixer needle located in said vertical delivery channel to deliver the powder through a nozzle in a controllable and adjustable fashion.

### FIELD OF THE INVENTION

This invention relates to 3D printing of metal.

### BACKGROUND OF THE INVENTION

Additive manufacturing, also known as 3D printing, has revolutionized how products are designed and manufactured. This technology allows for creation of complex shapes and geometries with a high degree of accuracy and repeatability. One of the most significant developments in additive manufacturing has been the ability to print with metal materials. Metal 3D printing, also known as metal additive manufacturing, involves using a 3D printer to build metal parts layer by layer from a digital model. The process begins with creating a 3D model using computer-aided design (CAD) software. This model is then sliced into thin layers and fed to the 3D printer, which builds the part by depositing and melting metal powders or wires layer by layer according to the design.

Metal powders are fine, dry particles of metal used in various industrial and manufacturing applications. They are typically produced through a process called atomization, in which molten metal is broken into tiny droplets that solidify into the powder form as they cool. Metal powders can be made from a wide range of metals, including aluminum, copper, titanium, and steel. One of the main benefits of metal powders is their ability to be easily formed into complex shapes and geometries. They can be used in processes such as powder bed fusion, binder jetting, and direct energy deposition to create metal parts through additive manufacturing or 3D printing. Metal powders can also be used as feedstock in traditional manufacturing processes such as sintering, casting, and forging.

Hopper and feeder systems are one type of prior art apparatus for storing and dispensing metal powder for various industrial processes, such as 3D printing or metal injection molding. The hopper is a container used to hold and store the metal powder, while the feeder is a device that regulates the flow of powder from the hopper to the point of use. The feeder can be adjusted to control the rate at which the powder is dispensed, and may also include features such as vibration or agitation to ensure a consistent flow of powder. There are several limitations to using hopper and feeder systems for delivering metal powders. One of the main limitations is that these systems are not suitable for handling very fine or reactive powders. Fine powders can easily become airborne and difficult to contain, which can lead to contamination and other issues. Reactive powders may react with the feeder system or the surrounding environment, causing problems. Another limitation of hopper and feeder systems is that they can be prone to blockages and other issues. The flow of metal powders through the system may not be consistent, resulting in uneven or inconsistent delivery. In addition, the feeder system may require regular maintenance to ensure it is functioning properly.

Gas-atomized feed systems are another method for delivering metal powders to equipment in additive manufacturing. In these systems, metal powders are delivered to the equipment through a gas stream, which helps to prevent contamination and reduce the risk of explosions. There are several limitations to using gas-atomized feed systems for delivering metal powders. One of the main limitations is the cost and complexity of these systems. Gas-atomized feed systems are generally more expensive and complex than hopper and feeder systems, and they require specialized knowledge and expertise to operate. Another limitation is that gas-atomized feed systems are not suitable for all types of metal powders. The powders must be able to withstand the high temperatures and pressures of the gas stream, and they must be compatible with the gas being used.

Slurry feed systems are another method for delivering metal powders to equipment in additive manufacturing. In these systems, metal powders are mixed with a liquid carrier and delivered to the equipment as a slurry. There are several limitations to using slurry feed systems for delivering metal powders. One of the main limitations is the cost and complexity of these systems. Slurry feed systems are generally more expensive and complex than hopper and feeder systems, and they require specialized knowledge and expertise to operate. Another limitation is that slurry feed systems are not suitable for all types of metal powders. The powders must be able to withstand the high shear forces of the slurry and must be compatible with the liquid carrier being used. In addition, the properties of the final product may be affected by the presence of the liquid carrier.

Overall, transporting metal powders on a small scale is a complex and challenging task that requires consideration of the specific requirements of the powders being transported. This is because metal powders are sensitive to moisture, temperature, and other environmental conditions, which may make it difficult to transport them. In addition, metal powders may have specific handling and storage requirements, such as the need for protective equipment or special containers, which may increase the cost and complexity of transportation.

As a result, at least in part, of the foregoing complications, the cost of metal 3D printing equipment and materials is still relatively high, and the process is unsuitable for mass production. The quality of printed parts can also be affected by factors such as the size and shape of the part, the metal material used, and the printing technology employed.

### SUMMARY OF THE INVENTION

This invention is an improvement over the 3D printing apparatus disclosed in U.S. patent application Ser. No. 17/380,949, the entirety of which is incorporated by reference herein. The present invention is directed to an electrochemical metal 3D printer that addresses some of the issues with metal 3D printers and opens new avenues to create new materials. In the prevailing electrochemical metal 3D printing technologies, the smooth and clog-free delivery of metal powder through the electroplating solution to the substrate is a significant challenge. Specifically, powder dispensing has to be done through a very small orifice so that the shape of 3D build can be produced with desired resolution. Prior experience suggests that dispensing metal powder from a small orifice for a long duration (several hours) is highly challenging.

Powder starts agglomerating after interacting with liquid media before coming out of the small nozzle. The inventors have discovered a solution to this problem with an innovative metal powder delivery system/device capable of delivering and releasing microscopic metal powder onto the substrate at a smooth and controlled rate and without clogging. The apparatus and method described herein combine the working principle of electro-plating and the physical transportation of metal powder inside an electrolyte. A key feature of this invention is the mechanism to transport metal powder from the hopper to the final target point. The system uses a synchronized mechanical system and nipple action to create a path for metal particles to flow inside the channel without choking/clogging the system. As the metal powder contacts the cathode substrate and takes its negative charge, the positive metal ions in the electroplating solution form a coating on the deposited and negatively charged metal powder. As the metal powder is continuously deposited on prior layers, the electroplating process continues with the metal ions in the electroplating solution continuously coating the metal powder as it is deposited. This approach enables the user to control both the metal powder thickness and the coating thickness as well as the rate of overall electrochemical 3d printing, by controlling the rate of powder delivery. Generally, metal powder is in 10-100 μm thickness range, and coatings can be or the orders of less than ≈0.5 μm. Hence, having smooth, continuous and clog-free powder dispensing at the electrochemical metal 3D printing site can enhance the 3D build rate 1-2 orders of magnitude and make this near-room temperature metal 3D process practical.

The present invention benefits include at least the following advantages:
1. It is highly scalable, with the ability to transport from a tiny amount of metal particles to a high volume of material.
2. The metal powder dispenser of the invention can deliver metal powder in the air (gaseous) and liquid media. However, the main advantage is the ability to dispense powder in liquid medium without interruption.
3. The mechanism is self-cleaning. The major problem with the prior art powder delivery systems is the clogging/choking of powder inside the channel/nozzle. The system of the present invention cleans the passage and tip of the nozzle to increase the duration of electrochemical 3D printing.
4. Power consumption is a critical consideration in modern design, as it can significantly impact both cost and environmental sustainability. The present invention has low power consumption and can help reduce operating costs by reducing energy usage typically needed in laser or electron-beam-based metal 3D printing and extend the life of a product or system by reducing the amount of heat generated.
5. Durability and repeatability are critical factors in design, as they ensure that a product or system can withstand the rigors of use and perform consistently over time. The present invention provides consistent, reliable and long-term, low-maintenance operation.

Accordingly, there is presented according to the invention, a device for delivering powdered metal in a 3D printing operation the device having a housing defining a metal powder compartment, a powder delivery channel having a horizontal segment and a vertical segment, a spiral threaded drive rod situated in the horizontal segment and connected at a first end to a first drive motor, the spiral threads dimensioned to convey the metal powder along a length of the horizontal segment toward the vertical segment; and a mixing needle situated in the vertical segment and connected at a top end to a drive assembly that simultaneously drives the mixing needle rotationally and in a reciprocating up and down motion.

According to various embodiments of the invention, there may be a tube connected to a bottom end of the vertical segment and a nozzle connected to a bottom end of the nozzle, the mixing needle extending through the tube and nozzle.

According to still further embodiments, the mixing needle may include protrusions formed at a bottom end thereof.

According to other preferred embodiments, the drive assembly may include a first motor attached to a top end of the mixing needle, a first motor housing containing the first motor, a drive shaft connected to the first motor housing via a bearing, and a second motor connected to an opposite end of the drive shaft via an eccentric coupling.

According to further embodiments of the invention, there is provided a device for the 3D printing of coated metal powders, including: a powder delivery system and a liquid electroplating solution container located as to receive powder from the powder delivery system, the powder delivery system including: a housing defining a metal powder compartment, and a powder delivery channel having a horizontal segment and a vertical segment, a spiral threaded drive rod situated in the horizontal segment and connected at a first end to a first drive motor, the spiral threads dimensioned to convey the metal powder along a length of the horizontal segment toward the vertical segment; and a mixing needle situated in the vertical segment and connected at a top end to a drive assembly that simultaneously drives the mixing needle rotationally and in a reciprocating up and down motion.

The device may include a pair of electrodes, a first of which is configured to provide a charge to the powder delivered from the powder delivery system, a second of which is configured to impart an opposite charge to a substrate. The device may further include a metal powder contained in the metal powder compartment, and a liquid electroplating solution contained in the liquid electroplating solution container. The metal powder may be selected from steel powder (including but not limited to stainless steel), copper powder, nickel powder, tungsten powder, molybdenum powder, and the liquid electroplating solution may contain metal ions including gold metal ions, silver metal ions, platinum metal ions, copper metal ions, nickel metal ions, and tin metal ions.

### BRIEF DESCRIPTION OF DRAWINGS

The foregoing summary, as well as the following detailed description of the preferred invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 is an ECAM Representative 3D front view of a metal 3D printer according to an embodiment of the invention.

FIG. 2 is a front-sectional view of a metal 3D printer according to an embodiment of the invention.

FIG. 3 is a front sectional view of a metal 3D printer including an expanded view of the power container and screw conveyor area according to an embodiment of the invention.

FIG. 4 is a front sectional view of a metal 3D printer including an expanded view of the mechatronics area according to an embodiment of the invention.

FIG. 5 is a representation of the internal moving components of a metal 3D printer according to an embodiment of the invention.

FIG. 6 is a front sectional view of a metal 3D printer including an expanded view of the vertical channel according to an embodiment of the invention.

FIG. 7 is a sectional view of a nozzle portion of a metal 3D printer according to an embodiment of the invention.

Features in the attached drawings are numbered with the reference numerals set forth in Table 1.

TABLE 1
Reference numeral legend

| Reference numeral | Part |
|---|---|
| 1 | Housing |
| 2 | Material hopper |
| 3 | Conveyer motor |
| 4 | Conveyor channel |
| 4a | Horizontal segment |
| 4b | Vertical segment |
| 5 | Screw conveyer |
| 8 | Eccentric coupling |
| 9 | Reserved |
| 10 | Needle rotation motor |
| 13 | Nozzle tube |
| 14 | Motor housing |
| 15 | Nozzle |
| 16 | Needle mixer |
| 17 | Hopper lid |
| 18 | Bearing |
| 19 | Shaft |
| 20 | Needle reciprocation Motor |
| 21 | Projections |

### DETAILED DESCRIPTION OF THE INVENTION

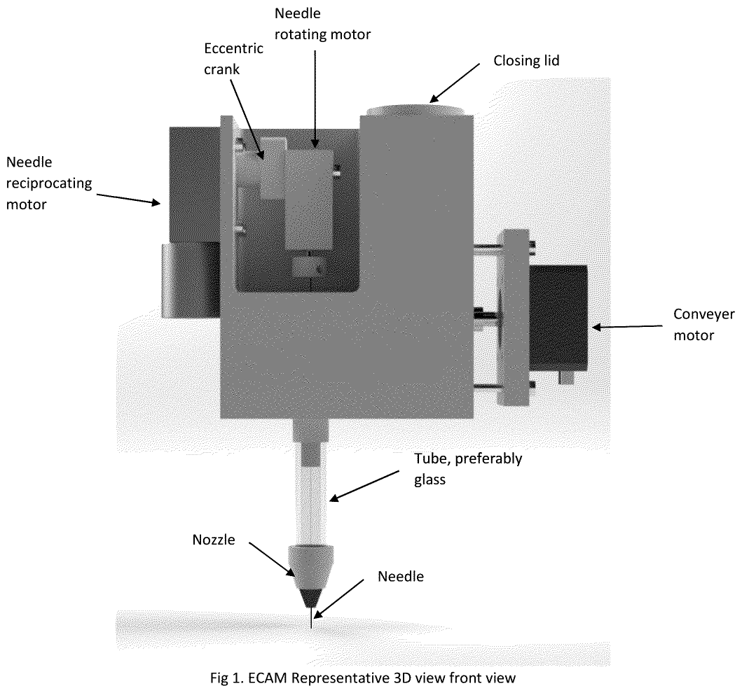

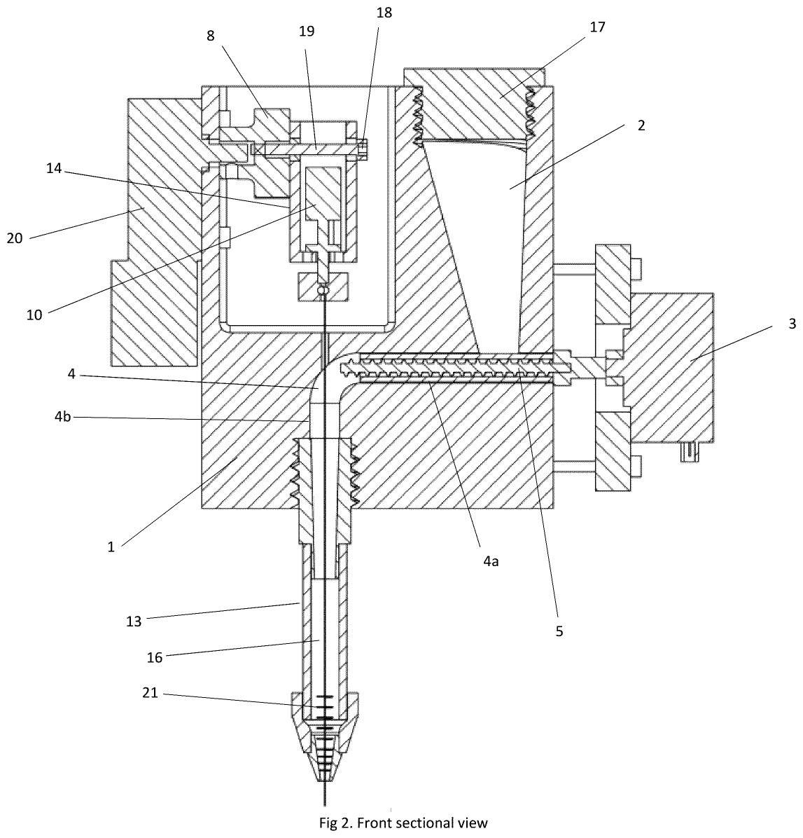

Referring to the non-limiting exemplary embodiment shown in FIGS. 1 and 2, a housing 1 defines a material hopper 2 onto which may be fitted a hopper lid 17. Housing 1, further defines a conveyor channel 4, having a horizontal segment 4a and a vertical segment 4b connected at a top end to the horizontal segment 4a. One end of horizontal segment 4a is open to a side of housing 1 and another end is in communication with a top end of the vertical segment. Inside the body of housing 1, a portion of the top surface of the horizontal segment 4a is open to the bottom of material hopper 2. A bottom end of the vertical segment 4b opens on a bottom surface of the housing 1.

A spiral-threaded rod or “screw conveyor” 5 is fitted inside the horizontal segment 4a of the conveyor channel 4 and extends the length of the horizontal segment 4a. A drive end of screw conveyor 5 is connected to conveyer motor 3 which rotationally drives screw conveyor 5. Tube 13 is connected to the bottom end of the vertical segment 4b of conveyor channel 4. Tube 13 may be connected to the bottom end of vertical segment 4b by any of various means. FIG. 1 shows the tube 13 connected to the bottom of vertical segment by a threaded connecter, with threads that interface with spiral grooves on an inside surface of the vertical channel 4b. A nozzle 15 is fitted to the bottom of tube 13.

An elongated needle or mixer 16 extends the length vertical segment 4b, tube 13 and nozzle 15, extending out of the bottom of the nozzle. A bottom portion of mixer 16 may be fitted with or formed with projections 21 or grooves in the shape of flanges, discs, plates, knobs, grooves or similar features. The top of mixer 16 extends out of the top of vertical segment 4b and is connected to a needle rotation motor 10 that rotationally drives mixer 16. Drive motor 10 rests within a motor housing 14. Drive shaft 19 is connected at one end to motor housing 14 via bearing 18 and at another end to a needle reciprocating motor 20 via eccentric coupling 8. Needle reciprocating motor 20 and eccentric coupling 8 work together to drive motor housing 14, and in turn motor 10 and needle 16, in an up and down reciprocating motion, while motor 10 drives needle 16 in a rotating motion.

The innovative feature of this design is the integration of reciprocal and rotational motion. As described above, this is achieved through the use of a first motor that is coupled with an eccentric crank to give the needle reciprocating motion, and a second motor to give the needle simultaneous rotating motion. According to a preferred embodiment, the mixer needle is preferably made from stainless steel spring wire and tag welded to create turbulence that enhances particle flow. The placement of the motors described herein is not central to the innovation. While conveyer motor 3 and needle reciprocating motor 20 are shown attached to the outside of the housing 1, they may one or both be incorporated into an interior of the housing. While needle rotating motor 10 is shown as located in an interior compartment or recess in housing 1, it may be located above the housing. The DC motors displayed may be replaced with other types of motors or drive machines. Any changes to the embodiments described herein are considered to be within the scope of the invention, provided that metal powder is delivered through a vertical tube via a reciprocating and rotating needle.

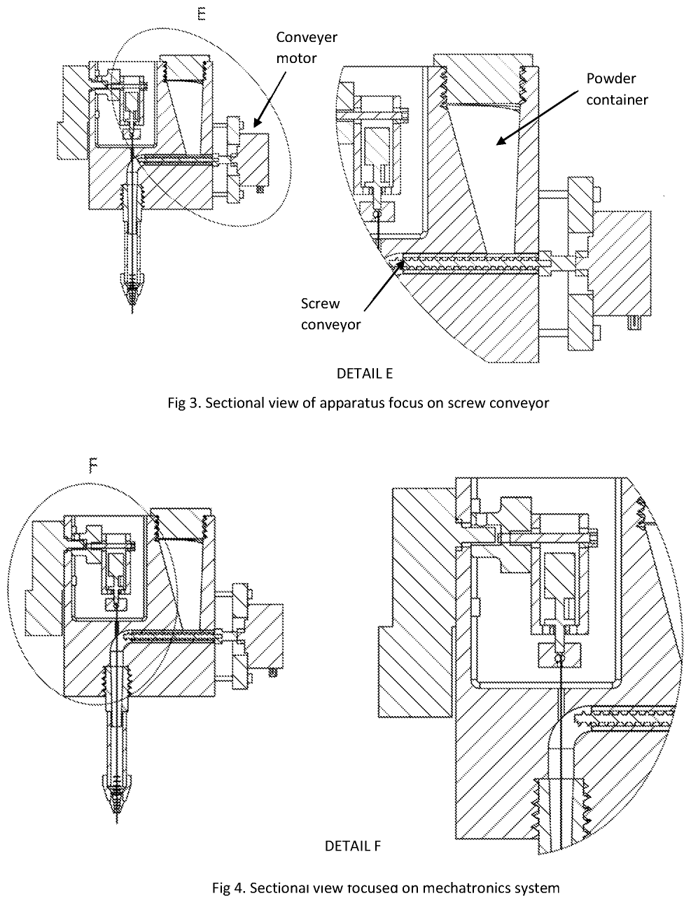

Metal powder delivery takes place in successive stages. First, metal powder is stored inside the hopper and sealed with a lid so that particles do not escape the hopper. To drive the metal powder from the hopper, the screw conveyor system is rotationally driven by a motor (see detail, FIG. 3), and the metal particles are carried horizontally through the horizontal segment of the conveyor channel until it falls into the vertical segment. The amount of powder delivered is controlled by the speed, pitch, and diameter of the screw conveyor.

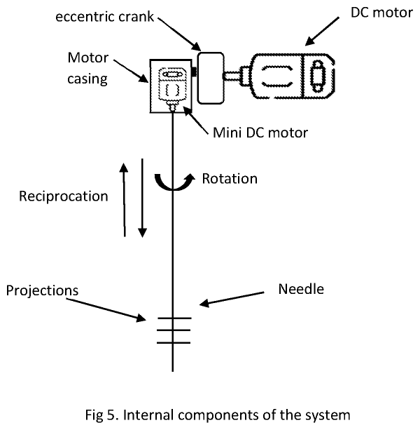

The reciprocating and rotational action of the needle deliver the power out through the nozzle. The stroke of the needle, which is the distance between the center of the crank and the axis, is precisely controlled by adjusting the distance between these two components (see, e.g., FIGS. 4 and 5). This mechanism allows for a highly precise and efficient movement, especially including when the nozzle is submerged in an electroplating solution.

The invention features exceptional scalability, capable of efficiently handling the transportation of a wide range of metal particle quantities, from small to large volumes with ease.

The invention features exceptional flexibility in forming a wide range of new materials due to the ability to dispense a wide range of powdered metals, including stainless steel, copper, nickel, tungsten, molybdenum, coupled with the standard and wide range of coating materials, including gold, silver, platinum, copper, nickel, tin, etc., that can be electrochemically coated onto the dispensed powder. Combining various metal powders with various coating materials opens doors for developing innovative materials with unprecedented physicochemical properties for a wide range of applications, such as catalyst development for energy generation and heat exchangers.

The present invention provides for the delivery of metal particles in both gaseous and liquid mediums. This allows for transport/delivery of metal particles in a wide range of environments, effectively operating in atmospheric conditions as well as in both internal and external liquid mediums.

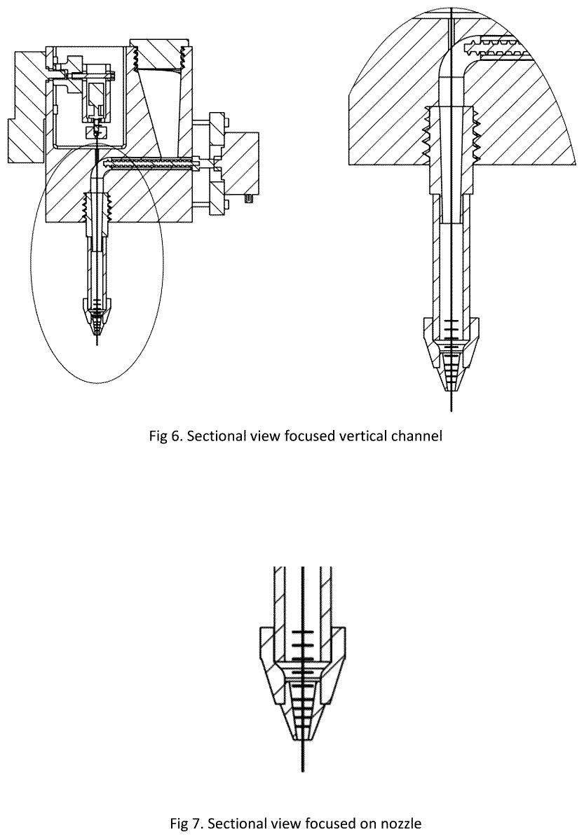

The invention combination of reciprocating and rotation action of the mixing needle also advantageously provides self-cleaning functionality. One of the major challenges associated with powder delivery systems is the occurrence of clogging or choking within the delivery channels, which can be difficult to predict and prevent. However, the present invention addresses this issue, actively maintaining the cleanliness of the passage and tip of the nozzle, ensuring smooth and uninterrupted powder flow. This significantly reduces the likelihood of clogging and choking, which helps to enhance the performance and reliability of the system (see, e.g., FIGS. 6 and 7).

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A device for delivering powdered metal in a 3D printing operation comprising:
a housing defining a metal powder compartment, and a powder delivery channel having a horizontal segment and a vertical segment,
a spiral threaded drive rod situated in said horizontal segment and connected at a first end to a first drive motor, said spiral threads dimensioned to convey said metal powder along a length of said horizontal segment toward said vertical segment;
a mixing needle situated in said vertical segment and connected at a top end to a drive assembly that simultaneously drives said mixing needle rotationally and in a reciprocating up and down motion.

2. A device according to claim 1, further comprising a tube connected to a bottom end of said vertical segment and a nozzle connected to a bottom end of said nozzle, said mixing needle extending through said tube and nozzle.

3. A device according to claim 1, said mixing needle comprising protrusions formed at a bottom end thereof.

4. A device according to claim 1, wherein said drive assembly comprises a first motor attached to a top end of said mixing needle, a first motor housing containing said first motor, a drive shaft connected to said first motor housing via a bearing, and a second motor connected to an opposite end of said drive shaft via an eccentric coupling.

5. A device for the 3D printing of coated metal powders, comprising:
a powder delivery system and a liquid electroplating solution container located as to receive powder from said powder delivery system,
said powder delivery system comprising:
a housing defining a metal powder compartment, and a powder delivery channel having a horizontal segment and a vertical segment,
a spiral threaded drive rod situated in said horizontal segment and connected at a first end to a first drive motor, said spiral threads dimensioned to convey said metal powder along a length of said horizontal segment toward said vertical segment; and
a mixing needle situated in said vertical segment and connected at a top end to a drive assembly that simultaneously drives said mixing needle rotationally and in a reciprocating up and down motion.

6. A device according to claim 6, further comprising an a pair of electrodes, a first of which is configured to provide a charge to said powder delivered from said powder delivery system, a second of which is configured to impart an opposite charge to a substrate.

7. A device according to claim 7, further comprising a metal powder contained in said metal powder compartment, and a liquid electroplating solution contained in said liquid electroplating solution container.

8. A device according to claim 8, wherein said metal powder is selected from the group consisting of steel powder, copper powder, nickel powder, tungsten powder, molybdenum powder, and wherein said liquid electroplating solution contains metal ions, said metal ions selected from the group consisting of including gold metal ions, silver metal ions, platinum metal ions, copper metal ions, nickel metal ions, and tin metal ions.
